(19) United States
(12) Patent Application Publication
(10) Pub. No.: US 2005/0272838 A1
(43) Pub. Date: Dec. 8, 2005

(54) Durable flame retardant finish for cellulosic materials

(76) Inventors: Charles Yang, Athens, GA (US); Weidong Wu, Forest, VA (US); Jeffrey K. Stowell, Ramsey, NJ (US); Edward D. Weil, New York, NY (US)

Correspondence Address: DILWORTH & BARRESE, LLP, 333 EARLE OVINGTON BLVD., UNIONDALE, NY, 11553, US

(21) Appl. No.: 10/518,965

(22) PCT Filed: Jun. 20, 2003
(86) PCT No.: PCT/US03/19761

§ 371 Date: Aug. 1, 2005

Related U.S. Application Data
(60) Provisional application No. 60/390,860, filed on Jun. 20, 2002.

(51) Int. Cl. C08K 5/49

(52) U.S. Cl. 524/115

(57) ABSTRACT

A composition, for treating a cellulosic material, contains a hydroxyl-functional phosphorus ester containing at least two phosphorus atoms therein, a melamine formaldehyde resin, optionally one or more N-methylol functional resin(s), and a curing catalyst.

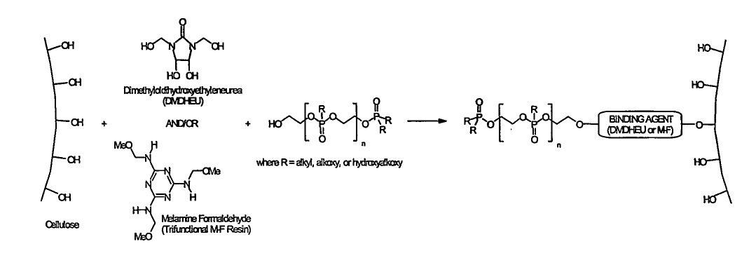

### BACKGROUND OF THE INVENTION

The present invention relates to flame retardant treatments for cellulose-containing materials, such as cotton and cotton blends (for example, cotton/Nomex®e cotton/Kevlar®, cotton/nylon-6, cotton/nylon-6,6, cotton/polyester, etc.), which renders such materials durable to both laundering and dry cleaning operations.

There are currently several different types of chemical finishes that can be applied to cellulosic materials to impart flame retardant (“FR”) properties. Of these systems, only a few create finished fabrics that can be laundered and dry-cleaned without losing their FR qualities. These treatments are generally referred to as “durable FR finishes” and, for the most part, can be summed up by referencing two types of commercial finishing chemistries: precondensate ammonia cure; and N-methylol functional phosphorus esters. It is surprising that more than thirty years have passed since these chemistries were first developed, and even more surprising that other technologies have been developed to supplant their hold on the FR cotton market during that period of time. For persons that have used and/or read about these finishing chemistries, it is understandable why they remain the dominant means for creating durable FR cotton fabrics. Nevertheless, those same people will also admit that there are limitations and, in many cases, undesirable facets to these finishing techniques.

There have been several versions of the tetrakis(hydroxymethyl)-phosphonium chloride (“THPC”) cross-linking chemistry used over the years, with the precondensate-NH₃ process being the most recent of these versions. Although the precondensate-NH₃ process may easily be the most durable treatment on the market, the technology is far from simple. The application process involves the use of an ammoniation chamber and strict control of application conditions to obtain consistent results. In addition to demanding application conditions, the costs for implementing this technology, licensing expenses, and the regulatory issues associated with the use of ammonia gas make this technology far from ideal, especially to new arrivals to the market.

N-methylol functional phosphorus chemistry, although not as durable as the precondensate-NH₃ chemistry, has also found a wide customer base in the FR cotton industry due to its ease of application and its use of commonly available pad/dry/cure textile finishing equipment. Most N-methylol functional phosphorus chemistry is based on the use of dimethyl (N-hydroxymethylcarbamoyl-ethyl)phosphonate in conjunction with a melamine formaldehyde (“M-F”) crosslinking resin to enhance its FR performance, both of which contribute to the emission of significant levels of formaldehyde during both fabric application and the lifetime of the treated garments.

The need for the present invention arose from the limitations listed above, and the desire for alternative FR finishing chemistries and potential new markets (e.g., furniture upholstery, raised surface fabrics) that only need an FR treatment to withstand a limited number of machine launderings. The main goals of the present invention were to develop an ER finishing chemistry that would have minimal effect on the physical characteristics of the treated fabrics (e.g., on strength retention, hand, dye shade, etc.), would be applicable using the traditional pad/dry/cure finishing equipment, and would use only commonly available commodity chemicals. The outcome of the invention was the development of several new FR finishing chemistry embodiments based on the use of a hydroxyl-functional organophosphorus FR additive in certain durable press (“DP”) finishing formulations containing commonly available components.

### SUMMARY OF THE PRESENT INVENTION

The conceptualization and subsequent development of the new FR finishing chemistry based on the use of a hydroxyl-functional organophosphorus FR additive with commonly available durable press (“DP”) finishing resins has been validated on full-scale applications equipment in several textile mills. The durability of the new FR finishes is believed to be based on the covalent binding between the FR additive and dimethyloldihydroxyethylene urea (DMDHEU) or melamine-formaldehyde (M-F) and that between cotton cellulose and DMDHEU or M-F. It is accomplished by using a formulation containing that hydroxyl-functional FR additive, a melamine-formaldehyde resin, optional N-methylol functional crosslinking resin(s), and a curing catalyst using common pad/dry/cure application equipment. The Figure, which forms a part of the instant specification, illustrates this novel chemistry.

### DESCRIPTION OF THE PREFERRED EMBODIMENTS

Although the concept of creating a semi-durable (five or less launderings) FR finish from a certain type of hydroxyl-functional phosphorus-containing ester compound and an N-methylol functional resin is known in the literature (see U.S. Pat. No. 3,746,572, which is incorporated herein in its entirety), previous results were quite limited in both the finish durability and the flame resistant properties of the treated fabrics. At best, these previous systems resulted in fabrics that could withstand at most five home launderings. Given this restriction and the commercial need for more durable and more flame resistant treatments, commercialization of such an older chemistry was never warranted.

An additional example of a flame retardant finishing chemistry similar to that described above is mentioned in PCT Patent Publication No. WO 00/29662. Although most of these functional resin systems show little commercial potential, the dimethyloldihydroxy-ethylene urea (DMDHEU) flame retardant resin systems are the exception, showing increased durability characteristics that may have commercial potential. Nevertheless, even though these systems show higher levels of durability than the previous chemistry described in U.S. Pat. No. 3,746,572, the practical utility of these new PR systems is limited to low addition level application systems such as on highly flammable general wearing apparel that fail to pass a simple 45-degree angle burn test. Using FR/DMDHEU add-on levels high enough to pass a vertical burn test will result in unacceptable fabric strength loss percentages equal to and sometimes exceeding 40%. Fabric strength loss percentages above 30% are rarely acceptable in commercial fabrics.

The present invention has improved this general area of chemistry and has resulted in the development of novel FR finishing systems that can hold up to more than 20-25 home launderings, while satisfying both a minimal strength loss to the fabric construction and the flammability requirements of a vertical burn test. These finishing chemistries are based on the use of melamine-formaldehyde (“M-F”), by itself or with an additional N-methylol functional resin (e.g., DMDHEU)), in combination with non-volatile hydroxyl-functional phosphorus esters containing a high level of phosphorus (for example, a hydroxyl number no more than about 300 mg KOH/g and a phosphorus content of no less than about 14 wt %). Examples of these products include the FYROLTEX® HP product and the high hydroxyl version of FYROL® PNX, both available from Akzo Nobel Functional Chemicals LLC.

Out of the FR products evaluated during the effort in developing the present invention, systems containing the high OH# oligomeric products FYROLTEX® HP and high hydroxyl version of FYROL® PNX showed efficacy in creating durable FR finishes. The FYROL® PNX product (OH#: <5 mg KOH/g), as well as the FYROL® 6 product (OH#: >400 mg KOH/g) both imparted poor FR properties to treated fabrics. As expected, the low hydroxyl product FYROL® PNX did not contain a sufficient quantity of functionality to bond it to the N-methylol functional resins. On the other hand, the FYROL® 6 product (the FR additive discussed in U.S. Pat. No. 3,746,572), which does contain hydroxyl functionality, also failed to provide an adequate FR finish. In the case of the FYROL® 6 product, the composition actually contained too many reactive groups per phosphorus atom (two hydroxyl groups per molecule and per phosphorus atom), resulting in the consumption of a large amount of the crosslinking resin with fixation of only a small amount of the FR additive onto the fabric substrate. Given that the level of the crosslinking resin used drastically affects the physical properties of the treated fabrics (e.g., strength, hand, etc.), the high levels of resin required for additives like FYROL® 6 makes them commercially impractical and undesirable. In addition to the above problem and its tendency to yellow fabrics, FYROL® 6 also displayed volatility problems under fabric curing conditions. Later phosphorus analysis of cured fabric samples showed a significant portion of the FR additive had volatilized into the ventilation system of the oven during application.

The results of the above experiments identified non-volatile hydroxyl-functional phosphorus esters containing a high level of phosphorus, a moderate level of hydroxyl functionality, and a thermal decomposition/volatilization temperature above 160° C. as the most desirable group of FR additives in these finishing systems. The combination of these FR product candidates (e.g, FYROLTEX® HP) and M-F based binding resin systems (including M-F/DMDHEU combinations) were developed to give a more desirable commercial FR finish over previously reported DP-based finishing systems (e.g., as described in U.S. Pat. No. 3,746,572 and PCT Patent Publication No. WO 00/29662).

Hydroxy-functional phosphorus ester candidates for use herein conform to the following formula: 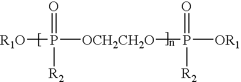
where R₁ is independently selected from alkyl and hydroxyalkyl, R₂ is independently selected from alkyl, alkoxy, and hydroxyalkoxy, and n is equal to or greater than 1.

In the composition of the present invention, the relative parts by weight of the essential components of the composition can be varied within the following exemplary limits: hydroxyl-functional phosphorus ester (from about 4 wt % to about 50 wt %), N-methylol functional resin(s) (from about 2 wt % to about 30 wt %), and a curing catalyst (from about 0.1 wt % to about 15 wt %), with water and other desired additives (fabric softener(s), surfactant(s), brightener(s), pH control agent(s), and the like) also being optionally present. The present formulation has a preponderant amount of the flame retardant component, as compared to the resin component, further differentiating it from the formulations described in PCT Patent Publication No. WO 00/29662.

Examples illustrating certain experimental work employing the FYROLTEX® HP and high OH# version of FYROL® PNX with the binding resin systems M-F and DMDHEU/M-F, in accordance with the present invention is given below:

### EXAMPLES

1. Binding Resins and Other Chemicals

FR additives used: FYROLTEX® HP or High OH# FYROL® PNX, which are hydroxyl functional oligomeric phosphorus ester products supplied by Akzo Nobel.
M-F resins used: ECCOREZ M300 supplied by Eastern Color & Chemical or AEROTEX® M-3 supplied by Noveon, which are trifunctional methylated melamine resins.
Glyoxal resin used: FREBREZ® 900 supplied by Noveon, an unbuffered, uncatalyzed DMDHEU resin.
Catalysts used: A 70% solution of phosphorous acid (also known as phosphonic Acid) supplied by Akzo Nobel; Catalyst 531 supplied by Omnova Solutions, a combination of magnesium chloride and citric acid solution; and Catalyst RD supplied by Omnova Solutions, ammonium chloride solution.
Wetting agent: TERGITOL® TMN-6 supplied by Dow Chemical, an alcohol ethoxylate surfactant.
Softener: CROSSLINK-SS305 supplied by Vulcan Performance Chemicals, a proprietary reactive silicon softener.
   2. Pad-Dry-Cure Equipment Used
Pad applicator (laboratory size): an instrument used to apply a solution to fabric at a specified level (% wet-pickup).
Curing oven (laboratory size): an oven that is used to dry and subsequently to cure the chemically treated fabrics at high temperatures.
Washing machine (household size): used for laundering fabrics after chemical treatment and curing with AATCC Standard Detergent 1993.
   3. Fabrics
100% Cotton scoured and bleached printcloth weighing 108 g/m² (Testfabrics Style 400).
100% Cotton dyed twill weave weighing 246 g/m².
50/50 Cotton/Nylon-6,6 dyed blend printed twill weave weighing 254 g/m²
35/65 Cotton/Nomex® blend twill weave weighing 192 g/m².
   4. Fabric Aftertreatments
Washing at 105° F. without the used of a detergent (water wash).
Launderings according to AATCC Test Method 124-1996 at 105° F. with AATCC Standard Detergent 1993 (home laundering washing/drying —HLWD).
   5. Fabric Flammability Testing Methods
Limiting Oxygen Index: ASTM D2863-00.
Vertical Burn: ASTM D6413-99.
   6. Fabric Physical Property Testing Methods
Tensile Strength: ASTM D5035-90.
Tearing Strength: ASTM D1424-96.
   General Application Conditions

The test fabrics were immersed into the desired test solution containing the FR finish formulation, then fed through a pad applicator to ensure that both the desired level of chemistry was applied to the fabric and also that it was applied in a uniform manner. Although it was standard practice to pad the chemicals on twice using two dips and two nips during the laboratory trials, the chemicals were only padded once in the full-scale mill trials and showed little difference in ultimate performance. After achieving 9, the desired wet pick-up level, the fabrics were dried and cured. After curing, a short afterwash procedure was performed at 140° F. to remove any unbound chemicals.

Experimental Results

I. Oligomeric FR Product with a M-F Binding Resin Applied to 100% Cotton Fabrics

108 G/M² Cotton Twill Treated with FYROLTEX ® HP/M-F

| Home Laundering | LOI (%)* |
|---|---|
| Before Water Wash | 33.0 |
| After Water Wash | 31.5 |
| 1 HLWD Cycle | 30.7 |
| 5 HLWD Cycles | 29.8 |
| 10 HLWD Cycles | 28.9 |

*Even though there is no pass/fail standard for the LOI measurement, equal to or over 27% is generally considered an acceptable pass/fail threshold for a vertical burn evaluation.
Notes:
1. Formula: 16.0% FYROLTEX ® HP, 8.0% ECCOREZ ® M300
2. The pH of the finish solution was adjusted to 4.0 by addition of H₃PO₃
3. A wet pick-up of 115% was achieved
4. Fabric: 100% cotton twill fabric weighing 108 g/m²
5. Drying Condition: 180° F. for 3.0 minutes
6. Curing Condition: 330° F. for 2.5 minutes

246 G/M² Cotton Twill Treated with FYROLTEX ® HP/M-F

| Home Laundering | LOI (%)* |
|---|---|
| Before Water Wash | 33.5 |
| After Water Wash | 30.5 |
| 1 HLWD Cycle | 30.2 |
| 5 HLWD Cycles | 29.0 |
| 10 HLWD Cycles | 28.0 |

*Even though there is no pass/fail standard for the LOI measurement, equal to or over 27% is generally considered an acceptable pass/fail threshold for a vertical burn evaluation.
Notes:
1. Formula: 16.0% FYROLTEX ® HP, 8.0% ECCOREZ ® M300
2. The pH of the finish solution was adjusted to 4.0 by addition of H₃PO₃
3. A wet pick-up of 75% was achieved
4. Fabric: 100% cotton twill fabric weighing 246 g/m²
5. Drying Condition: 180° F. for 3.0 minutes
6. Curing Condition: 330° F. for 2.5 minutes

An Example is also given to show the performance of the high OH# version of FYROL® PNX to that of FYROLTEX® HP, where both treatments show adequate FR performance. The lower LOI numbers for the High OH# FYROL® PNX treated fabrics are in part due to the product's lower phosphorus content; FYROLTEX® HP has a percent phosphorus of 20.5 wt % and high OH# FYROL® PNX only 15.5 wt %.

246 G/M² Cotton Twill Treated with FYROLTEX ® HB/M-F
and High OH# FYROL ® PNX/M-F

| FR | M-F | | LOI (%)* | | |
|---|---|---|---|---|---|
| (%) | (%) | pH | Before | Water Wash | 5 HLWD |
| FYROLTEX ® HP | 12 | 4.0 | 36.5 | 34.3 | 33.1 |
| 28% | | | | | |
| High Hydroxyl | 12 | 4.0 | 31.8 | 31.5 | 30.5 |
| FYROL ® PNX | | | | | |

*Even though there is no pass/fail standard for the LOI measurement, equal to or over 27% is generally considered an acceptable pass/fail threshold for a vertical burn evaluation.
Notes:
1. Formula: FR Additive, ECCOREZ ® M300
2. The pH of the finish solution was adjusted to 4.0 by addition of H₃PO₃
3. Fabric: 100% cotton twill fabric weighing 246 g/m²
4. Drying Condition: 180° F. for 3.0 minutes
5. Curing Condition: 330° F. for 2.5 minutes

II. Oligomeric FR Product with DMDHEU/M-F Binding Systems Applied to 100% Cotton Fabrics

Based on the above observations, work was also completed to evaluate combination DMDHEU/M-F binding systems that would incorporate the high durability of the DMDHEU binding systems and the high FR performance and low strength loss characteristics of the M-F binding systems. The tables below illustrate some of the results:

246 G/M² Cotton Twill Treated with FYROLTEX ® HP/DMDHEU/M-F
or FYROLTEX ® HP/M-F Systems

| | | | Tensile Strength | | Tear Strength | | | |
|---|---|---|---|---|---|---|---|---|
| | LOI (%)* | | Fill | Retention | Fill | Retention | Warp | Retention |
| Formula | 1 HLWD | 12 HLWD | (kgf) | (%) | (kgf) | Fill (%) | (kgf) | Warp (%) |
| 1 | 28.5 | 27.3 | 25.3 | 69 | 1.69 | 73 | 1.55 | 70 |
| 2 | 28.3 | 27.2 | 30.7 | 83 | 2.06 | 89 | 1.90 | 86 |
| 3 | 30.8 | 29.5 | 35.6 | 96 | 2.10 | 91 | 1.98 | 90 |
| Control | — | — | 36.9 | — | 2.32 | — | 2.21 | — |

*Even though there is no pass/fail standard for the LOI measurement, equal to or over 27% is generally considered an acceptable pass/fail threshold for a vertical burn evaluation.
Notes:
1. Formula 1: 24% FYROLTEX ® HP, 10.0% FREEREZ ® 900, 1.0% ECCOREZ ® M300, 6.0% Catalyst 531, 4.0% Crosslink-SS305, 0.01% TERGITOL ® TMN-6
2. Formula 2: 24% FYROLTEX ® HP, 2.0% FREEREZ ® 900, 3.0% ECCOREZ ® M300, 0.20% H₃PO₃, 4.0% Crosslink-SS305, 0.01% TERGITOL ® TMN-6
3. Formula 3: 24% FYROLTEX ® HP, 7.0% ECCOREZ ® M300, 0.20% H₃PO₃, 4.0% Crosslink-SS305, 0.01% TERGITOL ® TMN-6
4. A wet pick-up of about 80% was achieved
5. Drying Condition: 180° F. for three minutes
6. Curing Condition: 330° F. for two minutes

It is apparent from the data above, that as the level of the M-F resin used was increased and the level of DMDHEU resin was decreased, the improved fabric strength retention properties of the M-F containing systems was impressive. The FR/DMDHEU systems demonstrated a high level of effectiveness in binding the FR component to cotton cellulose and excellent laundering durability. The FR/DMDHEU systems bring with them a level of fabric strength loss similar to that of normal DP-type finishing chemistries (about 30-40% strength loss), the major reason for this is DMDHEU's high capacity to crosslink cotton cellulose. On the other hand, M-F resins are less effective at binding the ER component to cotton cellulose than DMDHEU. As a result, they cause far less cross-linking in cotton and consequently less strength loss in the treated fabrics. In addition to lower strength loss, the M-F resin systems also add an important source of nitrogen to the FR finishing system, thereby boosting their initial FR performance over that of the DMDHEU-based systems.

By combining an M-F resin with a DMDHEU resin in the same formulation, the FR finishing system can take advantage of the benefits imparted by both resin components. The PR/DMDHEU/M-F systems show a high level of flame retardancy after laundering, and at the same time have excellent fabric strength retention properties (80-90%). The DMDHEU resin improves binding of the FR component to cotton and the M-F resin enhances the flame retardant properties of the finish through nitrogen/phosphorus synergism, while also minimizing the overall fabric strength loss.

III. Oligomeric Fr Product and a DMDHEU/M-F Binding System Applied to Cotton Blend Fabrics (Cotton/Nylon and Cotton/Nones)

In addition to testing the combination FR/M-F/DMDHEU application formulations to 100% cotton fabrics, trials were also completed on some exemplary cotton blend fabrics. Two examples (namely, cotton/nylon and cotton/Nomex® blend fabrics) were tested as substrates and the results are set forth below:

254 G/M² Cotton/Nylon Blend Twill Treated with
FYROLTEX ® HP/DMDHEU/M-F System

| Home Laundering | LOI (%)* | Char Length (mm)* |
|---|---|---|
| Before Water Wash | 28.7 | 70 |
| 1 HLWD Cycle | 28.5 | 78 |
| 9 HLWD Cycles | 28.1 | 75 |
| 15 HLWD Cycles | 27.5 | 126 |

*A char length of over 178 is considered passing for the vertical burn test. Even though there is no pass/fail standard for the LOI measurement, equal to or over 27% is generally considered an acceptable pass/fail threshold for a vertical burn evaluation.
Notes:
1. Formula: 40.0% FYROLTEX ® HP, 6.0% FREEREZ ® 900, 6.0% AEROTEX ® M-3, 0.8% Catalyst RD, 0.02% TERGITOL ® TMN-6
2. A wet pick-up of 75% was achieved
3. Fabric: 50/50 cotton/nylon blend twill fabric weighing 254 g/m²
4. Drying Condition: 180° F. for three minutes
5. Curing Condition: 330° F. for two minutes

192 G/M² Cotton/NOMEX ® Twill Treated
with FYROLTEX ® HP/DMDHEU/M-F System

| Home Laundering | LOI (%)* | Char Length (mm)* |
|---|---|---|
| Before Water Wash | 37.1 | 76 |
| 1 HLWD Cycle | 35.3 | 64 |
| 12 HLWD Cycles | 35.2 | 74 |

*A char length of over 178 is considered passing for the vertical burn test. Even though there is no pass/fail standard for the LOI measurement, equal to or over 27% is generally considered an acceptable pass/fail threshold for a vertical burn evaluation.
Notes:
1. Formula: 20.0% FYROLTEX ® HP, 1.6% FREEREZ ® 900, 2.5% AEROTEX ® M-3, 2.0% Catalyst 531, 0.02% TERGITOL ® TMN-6
2. A wet pick-up of 89% was achieved
3. Fabric: 35/65 cotton/NOMEX ® blend twill fabric weighing 192 g/m²
4. Drying Condition: 180° F. for 3.0 minutes
5. Curing Condition: 330° F. for 2.0 minutes

Depending on the FR properties, durability requirements, and fabric strength properties (e.g., tensile and tear strength retention) desired for a target end-use application, an appropriate FR/DMDHEU/M-F or FR/M-F system can be formulated to meet those needs.

The foregoing Examples are presented merely to illustrate certain embodiments of the present invention and should not be construed in a limiting sense for that reason. The scope of protection sought is set forth in the claims that follow.

1. A composition, for treating a cellulosic material, which comprises a hydroxyl-functional phosphorus ester containing at least two phosphorus atoms therein, a melamine-formaldehyde resin, optionally one or more N-methylol functional resin(s), a curing catalyst.

2. A composition as claimed in claim 1 wherein the curing catalyst is an ammonium salt.

3. A composition as claimed in claim 1 wherein the curing catalyst comprises a mixture of a Lewis acid catalyst and a carboxylic acid.

4. A composition as claimed in claim 3 wherein the carboxylic acid is citric acid.

5. A composition as claimed in claim 3 wherein the Lewis acid catalyst is magnesium dichloride.

6. A composition as claimed in claim 1 wherein the curing catalyst is selected from the group consisting of phosphorus acid and phosphoric acid.

7. A composition as claimed in claim 1 wherein the hydroxyl-functional phosphorus ester is selected from the group consisting of a mixed phosphate/phosphonate ester of CAS No. 70715-06-09 and a phosphate ester formed by reacting triethyl-phosphate, phosphorus pentoxide, ethylene glycol and ethylene oxide.

8. A composition as claimed in claim 1 wherein the hydroxyl-functional phosphorus ester is a mixed phosphate/phosphonate ester.

9. A composition as claimed in claim 1 wherein the hydroxyl-functional phosphorus ester is a polyphosphate.

10. A composition as claimed in claim 1 wherein the hydroxyl-functional phosphorus ester is a polyphosphonate.

11. A composition as claimed in claim 1 wherein the composition contains DMDHEU as the N-methylol functional resin.

12. A composition as claimed in claim 1 wherein the curing catalyst is an ammonium chloride solution, the hydroxyl-functional phosphorus ester is selected from the group consisting of a mixed phosphate/phosphonate ester of CAS No. 70715-06-9 and a phosphate ester formed by reacting triethyl phosphate, phosphorus pentoxide, ethylene glycol and ethylene oxide, and the composition contains DMDHEU as the N-methylol functional resin.

13. A composition as claimed in claim 1 wherein the curing catalyst comprises a mixture of magnesium dichloride and citric acid, the hydroxyl-functional phosphorus ester is selected from the group consisting of a mixed phosphate/phosphonate ester of CAS No. 70715-06-9 and a phosphate ester formed by reacting triethyl phosphate, phosphorus pentoxide, ethylene glycol and ethylene oxide, and the composition contains DMDHEU as the N-methylol functional resin.

14. A composition as claimed in claim 1 wherein the curing catalyst is phosphorous acid, the hydroxyl-functional phosphorus ester is selected from the group consisting of a mixed phosphate/phosphonate ester of CAS No. 70715-06-9 and a phosphate ester formed by reacting triethyl phosphate, phosphorus pentoxide, ethylene glycol and ethylene oxide and the composition contains DMDHEU as the N-methylol functional resin.

15. A composition as claimed in claim 1 wherein the hydroxyl-functional phosphorus ester conforms to the following formula: 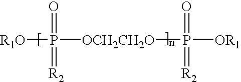
where R₁ is independently selected from alkyl and hydroxyalkyl, R₂ is independently selected from alkyl, alkoxy, and hydroxyalkoxy, and n is equal to or greater than 1.

16. A fabric that has been treated with the composition of claim 1.

17. A composition as claimed in claim 2 wherein the hydroxyl-functional phosphorus ester conforms to the following formula: 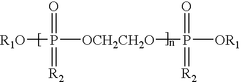
where R₁ is independently selected from alkyl and hydroxyalkyl, R₂ is independently selected from alkyl, alkoxy, and hydroxyalkoxy, and n is equal to or greater than 1.

18. A composition as claimed in claim 3 wherein the hydroxyl-functional phosphorus ester conforms to the following formula: 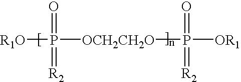
where R₁ is independently selected from alkyl and hydroxyalkyl, R₂ is independently selected from alkyl, alkoxy, and hydroxyalkoxy, and n is equal to or greater than 1.

19. A composition as claimed in claim 4 wherein the hydroxyl-functional phosphorus ester conforms to the following formula: 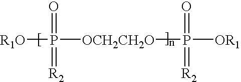
where R₁ is independently selected from alkyl and hydroxyalkyl, R₂ is independently selected from alkyl, alkoxy, and hydroxyalkoxy, and n is equal to or greater than 1.

20. A composition as claimed in claim 5 wherein the hydroxyl-functional phosphorus ester conforms to the following formula: 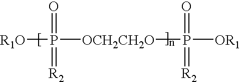
where R₁ is independently selected from alkyl and hydroxyalkyl, R₂ is independently selected from alkyl, alkoxy, and hydroxyalkoxy, and n is equal to or greater than 1.
